(19) United States
(12) Patent Application Publication
(10) Pub. No.: US 2002/0059280 A1
(43) Pub. Date: May 16, 2002

(54) Automated table installer for multiple heterogenous databases

(76) Inventor: Brian Slesinsky, Alameda, CA (US)

Correspondence Address: Edward Pennington, Swidler Berlin Shereff Friedman, LLP, Suite 300, 3000 K Street, N.W., Washington, DC, 20007-5116, US

(21) Appl. No.: 09/961,354

(22) Filed: Sep. 25, 2001

Related U.S. Application Data
(60) Provisional application No. 60/234,971, filed on Sep. 25, 2000.

(51) Int. Cl. G06F 7/00

(52) U.S. Cl. 707/100

(57) ABSTRACT

A method of maintaining databases in synchronism with software applications which support the databases in relation to installations includes obtaining a table schema employable by a database supported by a version of a software application. Table schema implemented by the database is synchronized to conform with the table schema employable by the database. The table schema implemented by the database is synchronized in association with an installation of the version of the software application. The table schema employable by the database is stored in a configuration file. The file is provided in a markup language including database representation table data associated with the version of the software application.

### BACKGROUND OF THE INVENTION

1. Field of the Invention

The present invention is generally directed to database systems. More particularly to a method, system and computer program product for maintaining a database in synchronism with software programs which support the database in relation to an upgrade or installation process.

2. Description of the Prior Art

Software applications often support a number of heterogeneous databases. Generally, there exists a distinct set of scripts within a software application for each database supported by the software application to provide data to, and retrieve data from, tables of each database. New versions of the software application are required to support and enable the upgrade of the tables in each database.

Typically, new versions of software applications are developed with additional computer program code so that users of previous versions may upgrade the tables in their database. Similarly, the addition of tables and the like to databases supported by a software application requires modification to the scripts for each database that provide data to, and retrieve data from the tables. These procedures are time consuming. Additionally, developers are required to be familiar with all the databases that are supported by a software application. Furthermore, since the scripts are manually created, they and tend include error that result in the database and software becoming out of sync with one another.

There is a need for a new method of maintaining databases in synchronism with software programs which support the databases in relation to an upgrade or installation process. There is a need for a new method of upgrading tables in a database to operate with a new version of a software application. There is also a need for a new method of updating scripts to support a schema for a database. There is a further need for a new method of efficiently synchronizing software programs and databases in relation to upgrades. There exist a need for a new method of reducing potential synchronization errors when synchronizing software programs and databases in relation to upgrades that reduces. There is a need for a system for maintaining databases in synchronism with software programs which support the databases in relation to an upgrade or installation process. There is a need for a computer program product for maintaining databases in synchronism with software programs which support the databases in relation to an upgrade or installation process.

### SUMMARY OF THE INVENTION

According to embodiments of present invention, a method, a system and a computer program product for maintaining databases in synchronism with software programs which support the databases in relation to an upgrade or installation process are provided. A software installer provides a database-independent technique of representing the schema of database systems that are supported by software applications. The schema is depicted as a database representation table and stored in a configuration file. The installer determines if a schema implemented by a particular database system matches a schema employable by the particular database system as depicted by the database representation table in the configuration file. If the schema implemented by the particular database system does not match the schema employable by the particular database system, the installer performs the necessary operations to configure the schema implemented by the particular database system in accordance with the schema employable by the particular database system as depicted by the database representation table. This technique enables installations and upgrades of software applications to be performed without having to write code to update the schema for each database that is to be supported. It also allows scripts that are specific to any particular table column to be updated.

A method of maintaining databases in synchronism with software applications which support the databases in relation to installations includes obtaining a table schema employable by a database supported by a version of a software application. The method further includes synchronizing the table schema implemented by the database to conform with the table schema employable by the database. The synchronizing is in association with an installation of the version of the software application.

In an embodiment of the present invention, the method includes storing the table schema employable by the database in a configuration file. The file is provided in a markup language including database representation table data associated with the version of the software application.

In an embodiment of the present invention, the method includes determining that the table schema employable by the database conflicts with a table schema implemented by the database. Determining that the table schema employable by the database conflicts with the table schema implemented by the database includes reading the configuration file, examining the table schema implemented by the database, identifying schema data in the table schema employable by the database required in the table schema implemented by the database and adding the schema data to the schema implemented by the database. The method further includes performing an update installation of the software application.

In an embodiment of the present invention, synchronizing the table schema implemented by the database to conform with the table schema employable by the database includes creating schema data in the table schema implemented by the database according to the schema employable by the database. The method includes performing an initial installation of the software application.

A system for maintaining databases in synchronism with software applications which support the databases in relation to installations includes a first interface operable to obtain a table schema employable by a database supported by a version of a software application and a script maker operable to synchronize the table schema implemented by the database to conform with the table schema employable by the database. The synchronizing is in association with an installation of the version of the software application.

A computer program product for maintaining databases in synchronism with software applications which support the databases in relation to installations includes a computer readable medium and computer program instructions, recorded on the computer readable medium, executable by a processor. The computer program instruction perform the steps of obtaining a table schema employable by a database supported by a version of a software application and synchronizing the table schema implemented by the database to conform with the table schema employable by the database. The synchronizing is in association with an installation of the version of the software application.

### BRIEF DESCRIPTION OF THE DRAWINGS

FIG. 1 depicts a functional block diagram of a framework in which the present invention can find application;

FIG. 2 depicts a functional block diagram of a user system depicted in FIG. 1;

FIG. 3 depicts a functional block diagram of a system depicted in FIG. 1;

FIG. 4 depicts a functional block diagram of a system depicted in FIG. 1; and

FIG. 5 is a f low diagram of the operations performed by the software installer.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to embodiments of present invention, a method, a system and a computer program product for maintaining databases in synchronism with software programs which support the databases in relation to an upgrade or installation process are provided. A software installer provides a database-independent technique of representing the schema of database systems that are supported by software applications. The schema is depicted as a database representation table and stored in a configuration file. The installer determines if a schema implemented by a particular database system matches a schema employable by the particular database system as depicted by the database representation table in the configuration file. If the schema implemented by the particular database system does not match the schema employable by the particular database system, the installer performs the necessary operations to configure the schema implemented by the particular database system in accordance with the schema employable by the particular database system as depicted by the database representation table. This technique enables installations and upgrades of software applications to be performed without having to write code to update the schema for each database that is to be supported. It also allows scripts that are specific to any particular table column to be updated.

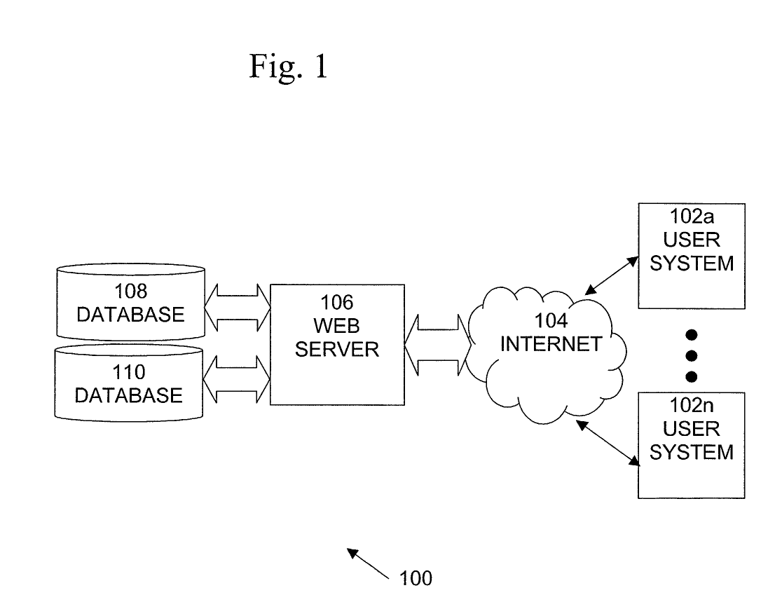

FIG. 1 depicts a functional block diagram of a framework in which the present invention can find application. In the embodiment of FIG. 1, framework 100 may be implemented to maintain databases in synchronism with software programs which support the databases in relation to an upgrade or installation process. Framework 100 includes user systems 102 connected to a system 106 employing network 104. Framework 100 may transmit using network 104, any combination of voice, video and/or data between devices. User systems 102 may be any apparatus from which, and to which, any combination of voice video and/or data may be transmitted over a network 104, such as the Internet or an extranet. User systems 102 can include computers, web access devices, workstations, telecommunication devices, and the like. Systems 102 may be used to access system 106 employing network 104.

System 106 couples to system 108 and network 104. System 106 can be any apparatus that provides process management services implemented by suitable class libraries, such as Java libraries and the functionality to maintain databases in synchronism with software applications which support the databases in relation to an upgrade or installation process. The libraries connect to systems and use resources as necessary. In the preferred embodiment of the present invention, system 106 supports a software installer employing a Java Application Programming Interface (“API”).

The system 108 may be any computer that stores raw data used by the Java API and provides object persistence. The database may connect to system 106 via a suitable interface, such as a Java Database Connectivity Standard (“JDBC”). User systems 102 and system 106 may connect to one another by means of a suitable communications network 104. Network 104 may be a local area network, a wide area network, the Internet, an extranet, a wireless network, or the like. The network 104 may transfer information between user system 102 and system 106. The information transferred may include any combination of voice, video and/or data. Network 104 can be implemented as a wireless network, a wired network, a satellite network, an electromagnetic network, fiber optic network or an infrared network. In addition, system 108 may directly transfer information to system 106 in response to a request for information as well as transfer information to user system 102 in response to a request made to system 106 by user system 102 over network 104.

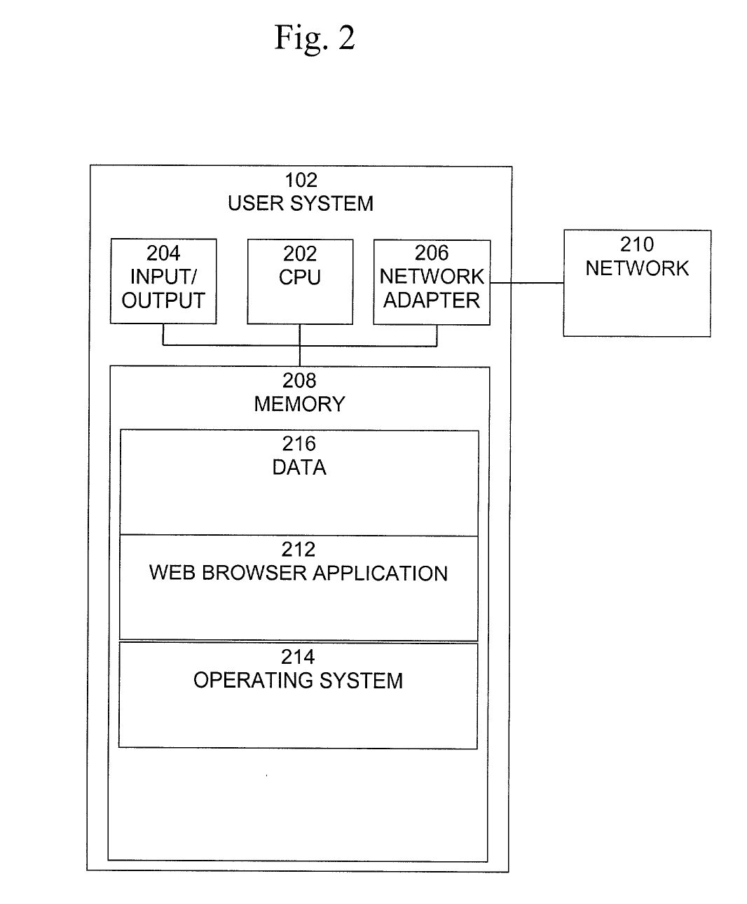

FIG. 2 is a block diagram illustration of user systems 102. The user systems 102 may include CPU 202, connected by a bus 408 or other suitable interface means to system memory 208. The user system 102 can also include input/output device interface, and display interface 204. Input/output device interface 204 enables interaction with and execution of instruction by user system 102 as directed by a user. Display interface can display information generated for output by user system 102 as provided by system 106.

As shown, the various components of the user system 102 communicate through a bus or similar architecture. Accordingly, systems memory 208 is disposed in communication with CPU 202 through bus. Systems memory 208 includes Browser Program 212, operating system 214 and data 216.

Operating system 214 provides overall system functionality. Browser Program 212 is computer program instructions executed by CPU 202. The browser program 212 enables the information transmitted from system 106 to be conveyed to users in a manner that can be understood by the users of user system 102. The browser program 212 serves as a front end to the World Wide Web on the Internet. The browser program 212 may be used to access system 106 to receive mark up language code, such as hypertext markup language (“HTML”)and system 108.

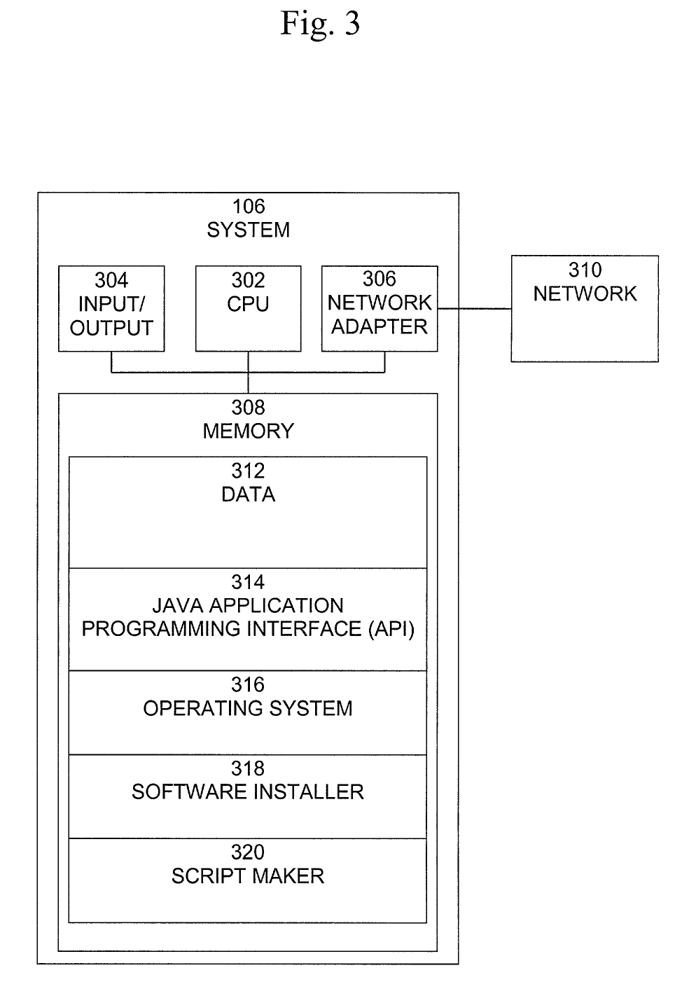

FIG. 3 is an exemplary block diagram of system 106 illustrated in FIG. 1, in which the present invention may be implemented. System 106 performs the function of maintaining databases in synchronism with software programs which support the databases in relation to an upgrade or installation process. In the FIG. 3 embodiment, system 106 is a general purpose computer, such as a workstation, personal computer, server or the like, but may be any apparatus that executes program instructions in accordance with the present invention. System 106 includes a processor (CPU) 302 connected by a bus 318 to memory 308, network interface 310 and I/O circuitry 304.

In the FIG. 3 embodiment, CPU 302 is a microprocessor, such as an INTEL PENTIUM® or AMD® processor, but may be any processor that executes program instructions in order to carry out the functions of the present invention. As shown, CPU 302 and the various other components of the system 106 communicate through a system bus 318 or similar architecture. Network interface 310 provides an interface between system 106 and a network 104, such as the Internet. The network 104 may be a local area network (LAN), a wide area network (WAN), or combinations thereof. I/O circuitry 304 provides an interface for the input of structured information to and output of structured information from system 106. I/O circuitry 304 includes input devices, such as trackball, mice, touchpads and keyboards, and output devices, such as printers and monitors.

In the FIG. 3 embodiment, memory 308 stores a Java Application Programming Interface (API) 314, operating system 316, data 312, software installer 318, and a script maker 320. During installation or an upgrade process for a software application, the software installer 318 loads a configuration file that describes the table structure (“schema”) employable by databases supported by the software application in a database-neutral manner. In a preferred embodiment, this configuration file is written in the Extensible Markup Language (XML). XML is preferable since it easily allows the schema to be written in a database-neutral manner. However, it should be apparent to one of ordinary skill in the art that any other markup language could be used, or this schema could be expressed in a table limited text file with name-value pairs, for example. The software installer 318 employs the Java API 314 to read the configuration file and generate SQL queries appropriate to the specific database at hand during the installation. The Java API 314 generates interfaces, such as markup language, for use on system 102, as executed by CPU 302. In one implementation of the invention, the Java API 314 may be of the type described in U.S. application Ser. No. 09/573,226, the disclosure of which is incorporated herein by reference. The Java API may be implemented employing virtually any programming language which results in a computer instructions executable by CPU 302, such as Java, C or C++.

A script maker 320 executes and returns an array of SQL statements specific to the database being used and creates a new set of tables from the previously loaded XML configuration. Operating system 316 provides overall system functionality. Data 312 may be any structured data required by system 106.

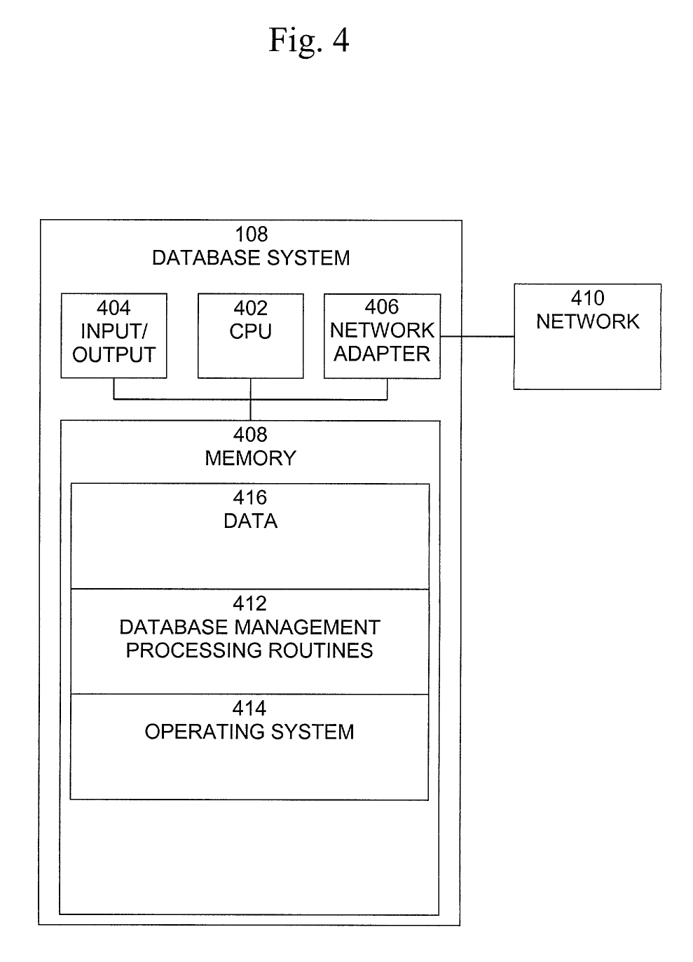

FIG. 4 is an exemplary block diagram of system 108 illustrated in FIG. 1, in which the present invention may be implemented. System 108 may store raw data used by the Java API and provides object persistence. In the FIG. 4 embodiment, system 108 is a general purpose computer, such as a workstation, personal computer, server or the like, but may be any computer that executes program instruction in accordance with the present invention. System 108 includes a processor (CPU) 402 connected by a bus 418 to memory 408, network interface 410 and I/O circuitry 404. System 108 mat be any one of a MS-SQL Server, a My-SQL, a Oracle, a Sybase, etc.

In the FIG. 4 embodiment, CPU 402 is a microprocessor, such as an INTEL PENTIUM® or AMD® processor, but may be any processor that executes program instructions in order to carry out the functions of the present invention. As shown, CPU 402 and the various other components of the server 108 communicate through a system bus 418 or similar architecture. Network interface 410 provides an interface between system 108 and a network 104, such as the Internet. The network 104 may be a local area network (LAN), a wide area network (WAN), or combinations thereof. I/O circuitry provides an interface for the input of structured information to and output of structured information from system 108. I/O circuitry 404 includes input devices, such as trackball, mice, touchpads and keyboards, and output devices, such as printers and monitors.

In the FIG. 4 embodiment, memory 408 stores data 416, such as raw, used by system 100. Memory 408 includes routines, such as database management routines 412, and operating system 414. Memory 408 includes memory devices, such as read only memory (ROM), random access memory (RAM) hard disks, CD-ROMs, floppy disks, optical storage devices, magnetic storage devices, etc. Operating system 414 provides overall system functionality, such as management of routines in memory 412. Management routines 412 provide data management functionality.

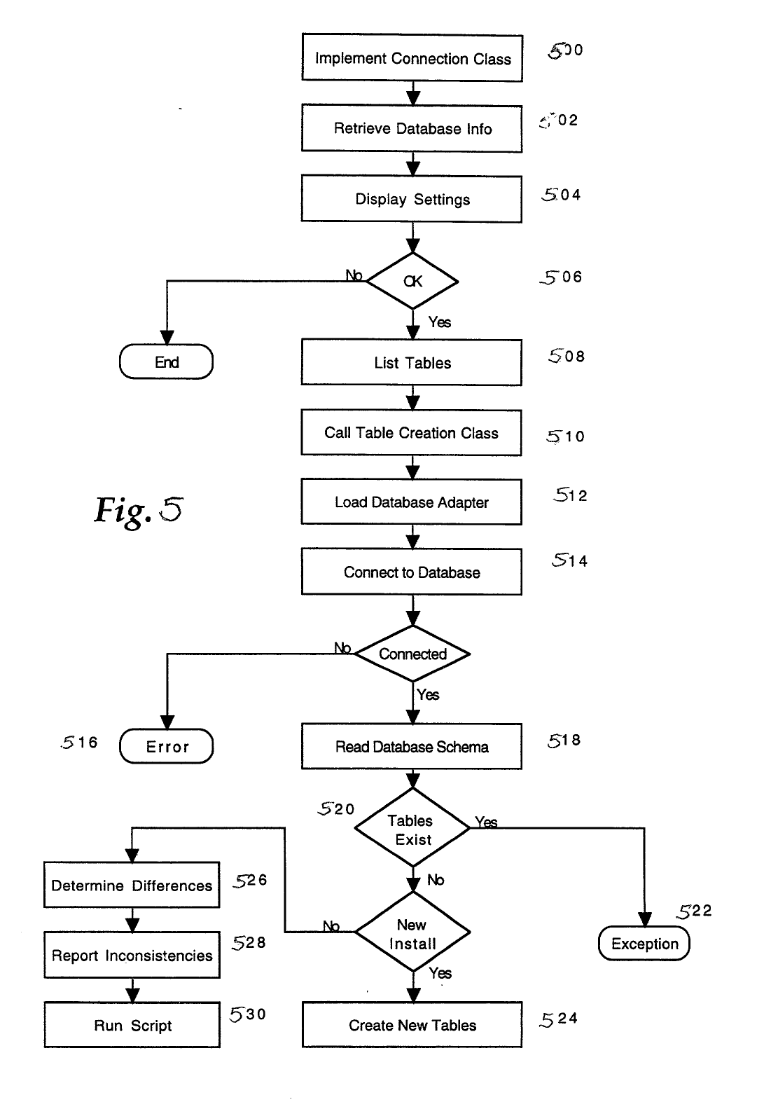

FIG. 5 is a flow diagram of the operations performed by the software installer 318 employing API 314. The API 314 first implements a connection class (500). This class is a wrapper implementation, which allows for exceptions to be generated if any unsupported operation is invoked. The connection class creates an SQL Java Interface. The SQL Java interface is used to retrieve information about a database, such as the driver employed, user information and all of the settings for the database (502). The settings may be displayed to the user (504) so all settings can be verified before a new or upgrade installation takes place (506). The SQL Java interface also reads the table schema and table names from the database, and lists all the tables in the schema that exist in the database (508). The SQL Java interface then calls a table creation class (510).

The table creation class implements an Adapter Connection interface, which calls a connection manager that retrieves the appropriate database adapter associated with the database and loads an appropriate driver (512), such as a JDBC driver. Then the Adapter Connection interface makes a SQL connection to the database via the driver (514). If a connection cannot be made then the user is presented with an error message (516). If the connection is made, the Adapter Connection interface reads a configuration file created by the software installer to obtain the schema for each of the supported databases (518). The Adapter Connection interface then checks to see if there are any tables already existent in the database (520). In the event that the tables already exist in the database, an exception is generated to let the user know that the wrong database has been selected as the implemented database.

If a new installation is taking place, a script maker 320 executes (524) and returns an array of SQL statements specific to the database and creates tables in accordance with the schema in the configuration file for the database. If, however, an upgrade of a software program is being installed, the software installer 318 initiates an abstract class, which implements a difference algorithm to determine if there are any inconsistencies between the schema implemented by the database system and the schema employable by the database system as depicted in the database representation table file (“configuration file”) (526). The difference algorithm determines what tables and columns are missing from the schema implemented by the database by examining each item from the schema implemented by the database system and the schema employable by the database system as provided in the configuration file. If there are inconsistencies, the installer outputs the exact nature of identified problems (528). Based upon which tables and columns are missing from the schema implemented by the database system, a script maker is implemented (530).

The script maker returns a script for creating a schema from scratch. The script maker can return an array of SQL statements, which are suitable for creating all of the necessary tables from scratch via JDBC. The SQL statements are based upon the particular database being used and the information that was located in the XML configuration file previously loaded by the installer. The script maker can also return an SQL statement for adding a column to a table in the case of a missing column or if a column needs to be added to a particular table during an upgrade installation. The script maker also determines if it supports the given column type or auto-increment based upon the given database type.

This procedure allows for easy database installations or upgrades, without having to hand craft scripts for each type of supported database or having to hand craft scripts specific to any particular table column. The installer also allows the user to parse all the database information into an XML file and displays the results, thereby allowing the user to instantly determine if the upgrade or new installation was successful.

The foregoing description of preferred embodiment of the present invention has been presented for purposes of illustration and description. It is not intended to be exhaustive or to limit the invention to the precise form disclosed. Obvious modifications or variations are possible in light of the above teachings. The embodiment disclosed herein is chosen and described in order to best illustrate the principles of the invention and its practical application, to thereby enable one of ordinary skill in the art to best utilize the invention in various embodiments and with various modifications as are suited to the particular use contemplated.

What I claim is:

1. A method of maintaining databases in synchronism with software applications which support the databases in relation to installations, the method comprising the steps of:
obtaining a table schema employable by a database supported by a version of a software application;
synchronizing the table schema implemented by the database to conform with the table schema employable by the database;
wherein the synchronizing is in association with an installation of the version of the software application.

2. The method according to claim 1, further comprising storing the table schema employable by the database in a configuration file.

3. The method according to claim 2, wherein the file is provided in a markup language including database representation table data associated with the version of the software application.

4. The method according to claim 2, further comprising determining that the table schema employable by the database conflicts with a table schema implemented by the database.

5. The method according to claim 4, wherein determining that the table schema employable by the database conflicts with the table schema implemented by the database includes reading the configuration file.

6. The method according to claim 5, wherein determining that the table schema employable by the database conflicts with the table schema implemented by the database includes examining the table schema implemented by the database.

7. The method according to claim 6, wherein determining that the table schema employable by the database conflicts with the table schema implemented by the database includes identifying schema data in the table schema employable by the database required in the table schema implemented by the database.

8. The method according to claim 7, wherein synchronizing the table schema implemented by the database to conform with the table schema employable by the database includes adding the schema data to the schema implemented by the database.

9. The method according to claim 8, further comprising performing an update installation of the software application.

10. The method according to claim 1, wherein synchronizing the table schema implemented by the database to conform with the table schema employable by the database includes creating schema data in the table schema implemented by the database according to the schema employable by the database.

11. The method according to claim 10, further comprising performing an initial installation of the software application.

12. A system for maintaining databases in synchronism with software applications which support the databases in relation to installations, the method comprising the steps of:
a first interface operable to obtain a table schema employable by a database supported by a version of a software application;
a script maker operable to synchronize the table schema implemented by the database to conform with the table schema employable by the database;
wherein the synchronizing is in association with an installation of the version of the software application.

13. The system according to claim 12, further comprising a configuration file operable to store the table schema employable by the database.

14. The system according to claim 13, wherein the configuration file is provided in a markup language including database representation table data associated with the version of the software application.

15. The system according to claim 13, further comprising a difference algorithm operable to determine that the table schema employable by the database conflicts with a table schema implemented by the database.

16. The system according to claim 15, wherein the difference algorithm is operable to read the configuration file.

17. The system according to claim 16, wherein the difference algorithm is operable to examine the table schema implemented by the database.

18. The system according to claim 17, wherein the difference algorithm is operable to identify schema data in the table schema employable by the database required in the table schema implemented by the database.

19. The system according to claim 18, wherein the script maker is operable to add the schema data to the schema implemented by the database.

20. The system according to claim 19, wherein an update installation of the software application is performed.

21. The system according to claim 12, wherein the script make is operable to create schema data in the table schema implemented by the database according to the schema employable by the database.

22. The system according to claim 21, wherein an initial installation of the software application is performed.

23. A computer program product for maintaining databases in synchronism with software applications which support the databases in relation to installations, the computer program product comprising:
a computer readable medium; and
computer program instructions, recorded on the computer readable medium, executable by a processor, for performing the steps of:
obtaining a table schema employable by a database supported by a version of a software application; and
synchronizing the table schema implemented by the database to conform with the table schema employable by the database;
wherein the synchronizing is in association with an installation of the version of the software application.

24. The computer program product according to claim 23, farther comprising computer program instruction for storing the table schema employable by the database in a configuration file.

25. The computer program product according to claim 24, wherein the file is provided in a markup language including database representation table data associated with the version of the software application.

26. The computer program product according to claim 24, further comprising computer program instruction for determining that the table schema employable by the database conflicts with a table schema implemented by the database.

27. The computer program product according to claim 26, wherein determining that the table schema employable by the database conflicts with the table schema implemented by the database includes reading the configuration file.

28. The computer program product according to claim 27, wherein determining that the table schema employable by the database conflicts with the table schema implemented by the database includes examining the table schema implemented by the database.

29. The computer program product according to claim 28, wherein determining that the table schema employable by the database conflicts with the table schema implemented by the database includes identifying schema data in the table schema employable by the database required in the table schema implemented by the database.

30. The computer program product according to claim 29, wherein synchronizing the table schema implemented by the database to conform with the table schema employable by the database includes adding the schema data to the schema implemented by the database.

31. The computer program product according to claim 30, further comprising computer program instruction for performing an update installation of the software application.

32. The computer program product according to claim 23, wherein synchronizing the table schema implemented by the database to conform with the table schema employable by the database includes creating schema data in the table schema implemented by the database according to the schema employable by the database.

33.The computer program product according to claim 32, further comprising computer program instruction for performing an initial installation of the software application.
